(19) United States
(12) Patent Application Publication
(10) Pub. No.: US 2013/0291390 A1
(43) Pub. Date: Nov. 7, 2013

(54) HANDLE FOR A SHAVING RAZOR

(71) Applicant: THE GILLETTE COMPANY, Boston, MA (US)

(72) Inventors: Chandrasen Gajria, Boston, MA (US); Kristopher William Schulz, Boston, MA (US)

(73) Assignee: THE GILLETTE COMPANY, Boston, MA (US)

(21) Appl. No.: 13/739,217

(22) Filed: Jan. 11, 2013

Related U.S. Application Data
(60) Provisional application No. 61/640,754, filed on May 1, 2012.

(51) Int. Cl. B26B 21/52

(52) U.S. Cl. CPC B26B 21/522
USPC 30/526

(57) ABSTRACT

A shaving razor comprising a handle comprising a head portion, a tail portion opposite the head portion, and a grip portion disposed between the head portion and the tail portion. The grip portion comprises an inner shaft spanning a length of the grip portion; an outer shaft coupled to the inner shaft, the outer shaft configured to be rotationally asymmetric to the inner shaft such that the outer shaft is not free to rotate about an axis along the length of the grip portion; and a gel grip coupled to the outer shaft, the gel grip having a Shore 000 hardness of less than about 80.

### FIELD OF THE INVENTION

The present invention relates to handles for shaving razors, and more particularly to handles having gel grips.

### BACKGROUND OF THE INVENTION

Various approaches for handles for shaving razors attempt to provide comfort and security to a user. It is believed that because of concerns with manufacturability and processing current approaches have commonly used handles made from plastic and/or metal. Handles commonly use hard plastic and/or soft plastic. An example of a soft plastic includes thermoplastic elastomers. Known thermoplastic elastomers, while perhaps presenting fewer concerns with manufacturing and processing, may not provide haptically desirable properties (e.g., weight and feel) for a user. Other materials may be known for use in a razor handle, but have not been implemented due to manufacturing and processing concerns. For example, gels may be known, but use of gels has been limited due to limited substrates to which gels can adhere to. Also, gels commonly loosen from the substrate and freely rotate about the substrate.

What is needed, then, are materials and construction of a handle for a shaving razor that preferably is stable and durable, and has desirable haptic properties for a user. What is also needed is a material that can preferably adhere or securely attach to a substrate for the handle of the shaving razor.

### SUMMARY OF THE INVENTION

One aspect of the invention provides a shaving razor comprising: a handle comprising a head portion, a tail portion opposite the head portion, and a grip portion disposed between the head portion and the tail portion. The grip portion comprises an inner shaft spanning a length of the grip portion; an outer shaft coupled to the inner shaft, the outer shaft configured to be rotationally asymmetric to the inner shaft such that the outer shaft is not free to rotate about an axis along the length of the grip portion; and a gel grip coupled to the outer shaft, the gel grip having a Shore 000 hardness of less than about 85.

The foregoing aspect may include any one or more of the following features. The outer shaft can be made from a different material than the inner shaft. The inner shaft can be made from metal. The inner shaft can be made from steel. The outer shaft can be made from plastic. The outer shaft can correspond in shape and can be configured to mate with the inner shaft. A cross-section of the inner shaft can be generally square. The outer shaft can comprise one or more ribs. A height of each of the one or more ribs can vary along the length of the grip portion. The height can flare from a head portion towards the tail portion. The gel grip can cover the outer shaft. The gel grip can circumscribe the outer shaft. The gel grip can cover completely the outer shaft. The gel grip can be configured to be rotationally asymmetric to the outer shaft such that the gel grip is not free to rotate about an axis along the length of the grip portion. The gel grip can have a Shore 000 hardness of less than about 65.

### BRIEF DESCRIPTION OF THE DRAWINGS

Other features and advantages of the present invention, as well as the invention itself, can be more fully understood from the following description of the various embodiments, when read together with the accompanying drawings, in which:

FIG. 1 is a perspective view of a shaving razor according to an embodiment of the invention;

FIG. 2 is a perspective view of a portion of a handle of a shaving razor in accordance with an embodiment of the invention;

FIG. 3 is a perspective view of a partial cross-section of the portion of the handle of FIG. 2;

FIG. 4 is a perspective view of a portion of a handle of a shaving razor according to an embodiment of the invention;

FIG. 5 is a cross sectional view of the portion of the handle taken along line A-A of FIG. 4; and

FIGS. 6A-6F depict various cross sections of an inner shaft of a handle in accordance with various embodiments of the invention.

### DETAILED DESCRIPTION OF THE INVENTION

Except as otherwise noted, the articles “a,” “an,” and “the” mean “one or more.”

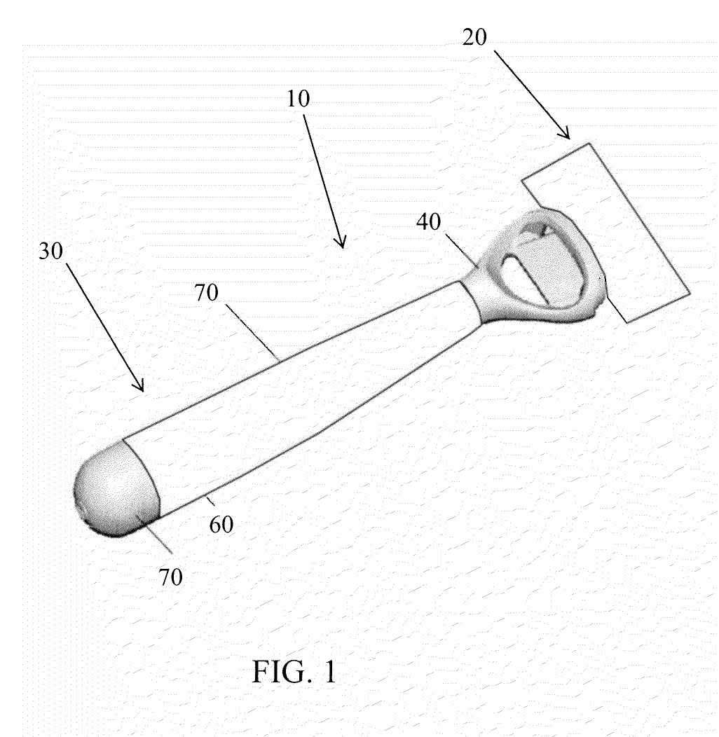

Referring to FIG. 1, a shaving razor 10 includes a razor cartridge 20 coupled to a handle 30. The handle 30 includes a head portion 40, a tail portion 50 opposite the head portion 40, and a grip portion 60 disposed between the head portion 40 and the tail portion 50. Covering at least a portion of the grip portion 60 is a gel grip 70. In an embodiment, the gel grip 70 circumscribes the grip portion 60, though the gel grip 70 may optionally circumscribe only partially or substantially all of the grip portion 50. Additionally or alternatively, the gel grip 70 covers all of the grip portion 60. In an embodiment, the head portion 40 may be made of soft plastic, hard plastic, metal, or combinations thereof. Additionally or alternatively, the head portion 40 may be configured to mate with the grip portion 60. In an embodiment, the head portion 40 can be coupled to the grip portion 60 in a variety of ways, e.g., via snap fit, press fit, bayonet connection, screw thread connection, etc. Additionally or alternatively, the head portion 40 is releasably engaged with the grip portion 60. The head portion 40 may include an eject button and/or a cartridge connecting assembly configured to couple to the razor cartridge 20. The tail portion 50 is configured to mate with the grip portion 60. The tail portion 50 may be made of soft plastic, hard plastic, metal, or combinations thereof. Preferably, the tail portion 50 is made of the same material as the head portion 40.

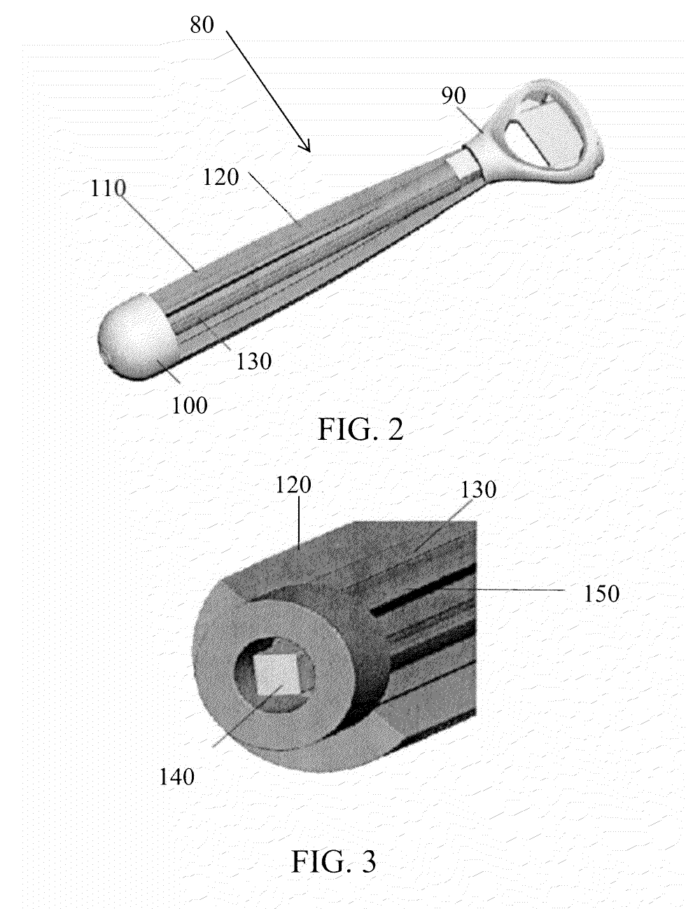

Shown in FIGS. 2 and 3 are portions of a handle 80. The handle 80 includes a head portion 90, a tail portion 100 opposite the head portion 90, and a grip portion 110. The grip portion 110 includes a gel grip 120 coupled to a shaft assembly. Although only a portion of the gel grip 120 is shown, in an embodiment, the gel grip 120 covers all of or substantially all of the grip portion 110. In an embodiment, the shaft assembly includes an outer shaft 130 and an inner shaft 140 coupled to the outer shaft 130. In an embodiment, the inner shaft 140 is made of metal, such as steel. Alternatively, the inner shaft 140 may be made from rigid plastic. Additionally or alternatively, the outer shaft 130 is made from plastic, such as hard plastic. Preferably, the gel grip 120 is made from a gel, such as a polyurethane or silicone gel. Nonlimiting examples of suitable gels are described in U.S. Patent Application Publication Nos. 2007/0143942; 2009/0035524; 2009/0039688; 2009/0142551; 2011/0233973; and 2011/0256353 and U.S. Pat. No. 7,827,704. Additionally or alternatively, the gel has a Shore 000 hardness of less than about 85, preferably less than about 60. Without intending to be bound by any theory, it is believed that such a gel provides desirable haptic properties for a user. For example, it is believed that such a gel may be more comfortable and secure during shaving. It is also believed that such haptic properties may provide for ease of maneuverability and use. In an embodiment, at least a portion of an exterior surface of the gel may be knurled. It is further believed that use of a gel grip with a portion of the shaft assembly being made of metal will also provide for desirable haptic properties as the weight of the metal may provide for comfort and maneuverability of the handle. As gels cannot be chemically bound to metal, the handle 80 preferably includes the outer shaft 130, which is preferably plastic. In an embodiment, the gel 120 may be comolded onto the outer shaft 130, which may act as a substrate. In known examples of hand held devices using gel grips, over time and use, the gel may freely rotate about a substrate. Shown in FIGS. 2 and 3 are portions of the outer shaft 130 that are configured to engage with the gel grip 120. Such portions are believed to facilitate securement of the gel grip 120, so as to mitigate free rotation of the gel grip 120 about the grip portion 110. In an embodiment, the portions of the outer shaft 130 may be one or more ribs 150. Fewer or more ribs 150 than shown may be used. The ribs 150 may extend from the outer substrate to engage the gel grip 120. Additionally or alternatively, the ribs 150 span more than half a length of the grip portion 110, preferably most of the length of the grip portion 110 and, alternatively, all of the length of the grip portion 110. In an embodiment, a height of each rib 150 is uniform along the length of the grip portion 110. Alternatively, the height of each rib 150 may vary along the length of the grip portion 110. In an embodiment, the height of each rib 150 flares towards an end of the grip portion 110. Each rib 150 may be uniform in shape and/or length to other ribs or at least one rib 150 may be different in shape and/or length from another rib 150. Additionally or alternatively, each rib 150 may be any arcuate, linear, non-linear, geometric, or polygonal shape.

It is believed that the ribs 150 help secure the gel 120, by providing sufficient interference therebetween, such that the gel 120 does not freely rotate or move about the grip portion 110. In such configurations, the outer shaft 130 and the gel 120 are rotationally asymmetric such that the gel 120 may not freely rotate about the outer shaft 130 when assembled. The thickness of the gel 120 may impact the shape of the ribs 150. For example, where the thickness of the gel is greater, the shape and/or dimension of the ribs may be correspondingly greater, e.g., higher ribs or a larger or more complex form to provide greater surface area for the gel to secure to. In an alternative embodiment to a gel grip, an exterior surface of a grip portion of a handle may be formed from an alternative plastic, such as an alternative soft plastic like a thermoplastic elastomer.

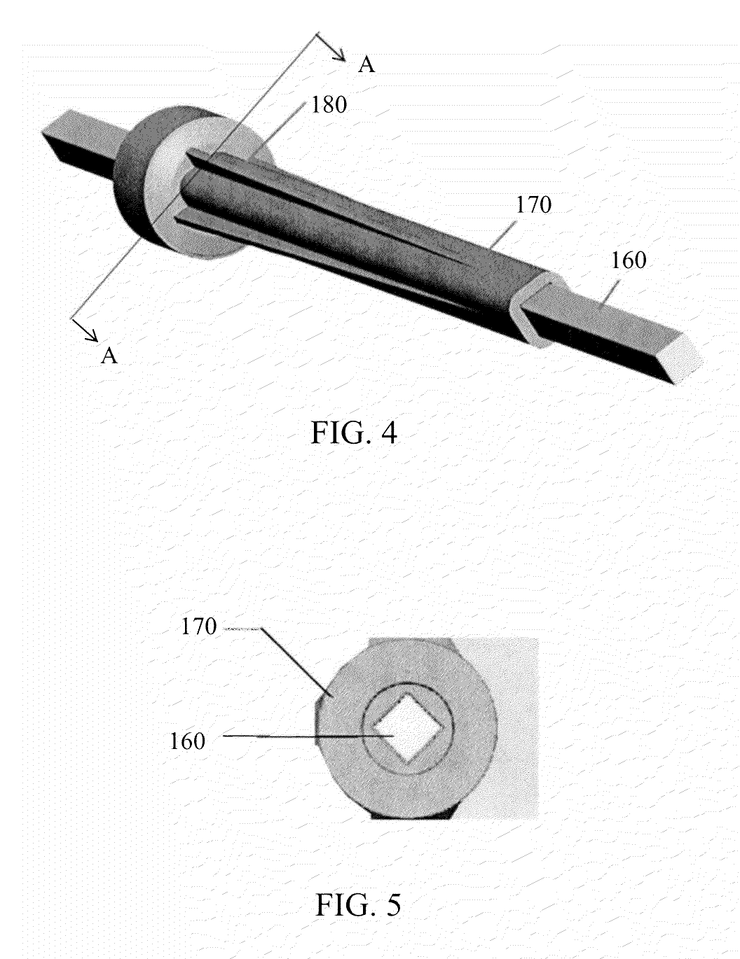

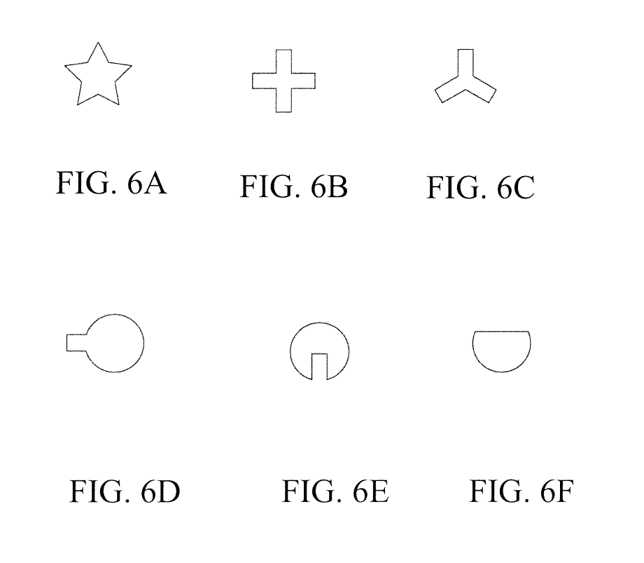

Referring now to FIGS. 4 and 5, a shaft assembly includes an inner shaft 160 coupled to an outer shaft 170, in which the outer shaft includes one or more ribs 180. The inner shaft 160 corresponds in shape and is configured to mate with the outer shaft 170. In an embodiment, the inner shaft 160 and the outer shaft 170 are configured to create at least an interference such that the outer shaft 170 cannot rotate relative to the inner shaft 160 when the two components are assembled. Additionally or alternatively, a cross section of the inner shaft 160 may be generally square or, optionally, any geometric, arcuate, or polygonal shape, except for a perfectly circular shape. For example, shown in FIGS. 6A-6F are various cross sections of embodiments of an inner shaft. The outer shaft 170 may define a recess, aperture, or cavity corresponding in shape to the inner shaft 160. For example, the outer shaft 170 may have a generally rectangular cavity and the inner shaft 160 may have a generally rectangular form (so as to have a generally square cross section). In such configurations, the inner shaft 160 and the outer shaft 170 are rotationally asymmetric such that the outer shaft 170 is not free to rotate about the inner shaft 160 when assembled. In an embodiment, the inner shaft 160 and the outer shaft 170 create an interference, when assembled, to avoid twisting or rotating of the outer shaft 170 around the inner shaft 160.

Referring to FIGS. 2-5, an inner shaft may extend along a length of a grip portion of a handle, preferably along the entire length of the grip portion. Additionally or alternatively, the inner shaft may extend along a length of the grip portion and a length of the tail portion, optionally, along the entire length of the grip portion and the entire length of the tail portion. In an embodiment, the inner shaft may be integrally formed with the head portion. Alternatively, the inner shaft may be integrally formed with the tail portion.

Embodiments detailed herein may also combine elements or components of the invention which are disclosed in general but not expressly exemplified in combination unless otherwise stated herein.

All parts, ratios, and percentages herein, in the Specification, Examples, and Claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving razor comprising:
a handle comprising a head portion, a tail portion opposite the head portion, and a grip portion disposed between the head portion and the tail portion, the grip portion comprising:
an inner shaft spanning a length of the grip portion;
an outer shaft coupled to the inner shaft, the outer shaft configured to be rotationally asymmetric to the inner shaft such that the outer shaft is not free to rotate about an axis along the length of the grip portion; and
a gel grip coupled to the outer shaft, the gel grip having a Shore 000 hardness of less than about 85.

2. The shaving razor of claim 1, wherein the outer shaft is made from a different material than the inner shaft.

3. The shaving razor of claim 2, wherein the inner shaft is made from metal.

4. The shaving razor of claim 3, wherein the inner shaft is made from steel.

5. The shaving razor of claim 2, wherein the outer shaft is made from plastic.

6. The shaving razor of claim 1, wherein the outer shaft corresponds in shape and is configured to mate with the inner shaft.

7. The shaving razor of claim 1, wherein a cross-section of the inner shaft is generally square.

8. The shaving razor of claim 1, wherein the outer shaft comprises one or more ribs.

9. The shaving razor of claim 8, wherein a height of each of the one or more ribs varies along the length of the grip portion.

10. The shaving razor of claim 9, wherein the height flares from a head portion towards the tail portion.

11. The shaving razor of claim 1, wherein the gel grip covers the outer shaft.

12. The shaving razor of claim 11, wherein the gel grip circumscribes the outer shaft.

13. The shaving razor of claim 12, wherein the gel grip covers completely the outer shaft.

14. The shaving razor of claim 1, wherein the gel grip is configured to be rotationally asymmetric to the outer shaft such that the gel grip is not free to rotate about an axis along the length of the grip portion.

15. The shaving razor of claim 1, wherein the gel grip has a Shore 000 hardness of less than about 65.
